(19) United States
(12) Patent Application Publication
(10) Pub. No.: US 2017/0017988 A1
(43) Pub. Date: Jan. 19, 2017

(54) FULL VALUE CALCULATOR FOR CONVERSIONS

(71) Applicant: GOOGLE INC., Mountain View, CA (US)

(72) Inventors: Vishal Goenka, Santa Clara, CA (US); Conrad Wai, San Francisco, CA (US); Bhanu Narasimhan, Los Gatos, CA (US); Surojit Chatterjee, Fremont, CA (US); Jyotirmaya Manoj Akkad, San Francisco, CA (US); Atul Bhandari, Sunnyvale, CA (US); Alexandra Baugher, San Francisco, CA (US); Shibani Sanan, Saratoga, CA (US); Hidetoshi Muta, Mountain View, CA (US)

(21) Appl. No.: 14/297,720

(22) Filed: Jun. 6, 2014

Related U.S. Application Data
(60) Provisional application No. 62/006,609, filed on Jun. 2, 2014.

(51) Int. Cl. G06Q 30/02

(52) U.S. Cl. CPC G06Q 30/0244; G06Q 30/0275; G06Q 30/0243

(57) ABSTRACT

Methods, systems, and apparatus include computer programs encoded on a computer-readable storage medium, including a method for updating campaigns. A content sponsor is identified that has one or more campaigns for presenting content to users. A prompt is provided to the content sponsor to provide one or both of conversion value information or estimates for one or more conversion actions, the estimates being for actions that are currently unable to be directly measured. The estimates are received. Rates for conversions are determined for each of the one or more conversion actions, including using the estimates and interaction data associated with the one or more campaigns to determine the rates. The determined rates are used to make a suggestion or automatically adjust one or more parameters associated with the one or more campaigns.

### CROSS-REFERENCE TO RELATED APPLICATION

This application claims priority to U.S. Provisional Application No. 62/006,609, filed on Jun. 2, 2014. The disclosure of the prior application is considered part of and is incorporated by reference in the disclosure of this application.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented.

### SUMMARY

In general, one innovative aspect of the subject matter described in this specification can be implemented in methods that include a computer-implemented method for providing content. The method includes identifying a content sponsor having one or more campaigns for presenting content to users. The method further includes providing a prompt to the content sponsor to provide one or both of conversion value information or estimates for one or more conversion actions, the estimates being for actions that are currently unable to be directly measured. The method further includes receiving the estimates. The method further includes determining, using one or more processors, rates for conversions for each of the one or more conversion actions including using the estimates and interaction data associated with the one or more campaigns to determine the rates. The method further includes using the determined rates to make a suggestion or automatically adjust one or more parameters associated with the one or more campaigns.

These and other implementations can each optionally include one or more of the following features. The conversion actions can be selected from the group comprising phone calls to an entity associated with the content sponsor, physical visit to a location associated with the content sponsor, purchase at a physical location associated with the content sponsor, offline conversion, or download of content or an application. Providing a prompt can include providing by a campaign management tool associated with the one or more campaigns a prompt in an interface associated with the campaign management tool. The estimates can be estimates for one or more time periods in the past. The estimates can be estimates for an amount of conversion actions that are attributable to presentation of content from the one or more campaigns. Determining the rates can further include identifying past rates for each of the conversion actions and estimating a future rate for the conversion actions based on respective ones of the determined rates. The method can further include determining when measured data is available for one or more of the estimates and using the measured data in lieu of the estimates when determining the rates. Using the determined rates can further include making a suggestion of a bid adjustment for at least one of the one or more campaigns. Using the determined rates can further include determining one or more goals of the content sponsor associated with a campaign of the one or more campaigns, evaluating the goals based at least on the determined rates, and making a suggestion to or automatically adjust a bid associated with the campaign. The method can further include presenting one or more of return on investment, net profit, margin, cost per action or another return metric to the content sponsor for a campaign of the one or more campaigns based on the received conversion value information and the determined rates. The method can further include determining estimated conversions that are attributable to user interactions, the estimated conversions represented by the received estimates and wherein determining rates is based on the attributable user interactions and a number of estimated conversions for a given conversion action. The one or more campaigns can include a first campaign and a second different campaign and wherein the first campaign and the second different campaign are in different accounts, both accounts owned by the same content sponsor. The estimates can be estimates for one or more segments of users wherein the segments are based on one or more of location, device type, or time of day/week. The method can further include comprising providing benchmarks for similar businesses in a similar geography to the content sponsor so as to facilitate the generation by the content sponsor of the estimates. The estimates can be based on benchmarks for similar businesses in a similar geography to the content sponsor. Prompting can include determining when estimates are not available from the content sponsor and using benchmarks for similar businesses in a similar geography to the content sponsor as a proxy for the estimates. Determining rates can include computing the rates based at least on identifying eligible user interactions and comparing the user interactions with other measured data.

In general, another innovative aspect of the subject matter described in this specification can be implemented in computer program products that include a computer program product tangibly embodied in a computer-readable storage device and comprising instructions. The instructions, when executed by one or more processors, cause the processor to: identify a content sponsor having one or more campaigns for presenting content to users; provide a prompt to the content sponsor to provide one or both of conversion value information or estimates for one or more conversion actions, the estimates being for actions that are currently unable to be directly measured; receive the estimates; determine rates for conversions for each of the one or more conversion actions including using the estimates and interaction data associated with the one or more campaigns to determine the rates; and use the determined rates to make a suggestion or automatically adjust one or more parameters associated with the one or more campaigns.

These and other implementations can each optionally include one or more of the following features. The conversion actions are selected from the group comprising phone calls to an entity associated with the content sponsor, physical visit to a location associated with the content sponsor, purchase at a physical location associated with the content sponsor, offline conversion, or download of content or an application

In general, another innovative aspect of the subject matter described in this specification can be implemented in systems, including a system comprising one or more processors and one or more memory elements including instructions. The instructions, when executed, cause the one or more processors to: identify a content sponsor having one or more campaigns for presenting content to users; provide a prompt to the content sponsor to provide one or both of conversion value information or estimates for one or more conversion actions, the estimates being for actions that are currently unable to be directly measured; receive the estimates; determine rates for conversions for each of the one or more conversion actions including using the estimates and interaction data associated with the one or more campaigns to determine the rates; and use the determined rates to make a suggestion or automatically adjust one or more parameters associated with the one or more campaigns.

Particular implementations may realize none, one or more of the following advantages. Estimates for conversions that are attributable to impressions or user interactions based on presentation of content provided by content sponsors can be used along with measured data to automatically generate suggestions (e.g., bid adjustments and/or budget adjustments) to content sponsors as to how to change campaigns to achieve campaign goals. Content sponsors can be provided with interfaces for performing “what-if analyses”, including predicting conversions and return on investment, based on suggested changes to campaigns. Using “measurement trumps estimation” techniques, automatic use of actual conversion rates and/or other information can prevent double counting of conversions when content sponsors provide their own estimates that are subsequently pre-empted by actual measured results. Content sponsors can be provided with estimates of specific segments, e.g., estimates for mobile conversions based on non-mobile or other estimates provided by the content sponsor. A full value calculator (FVC) can be implemented that uses both estimates provided by content sponsors along with measured data to determine value or other performance metrics associated with one or more campaigns. The FVC can help advertisers recognize the value of mobile impressions by factoring in conversions not recognized today (e.g., conventionally), including conversions from non-traditional mobile actions, and give advertisers a fuller picture of return on investment (ROI) and more confidence to buy mobile inventory. FVC can be used to determine optimal values for mobile bids per campaign by assembling the full picture of conversion data across all devices. The optimal values can be derived from the conversion data the content serving system has about the advertiser campaigns and the conversion data the content sponsors provide. The data entered into FVC by the advertiser can also be used to guide automated bidding.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content.

FIG. 2A shows an example user interface for displaying conventional conversion information.

FIG. 2B shows an example user interface including a prompt for entering estimates, values and/or other conversion information.

FIG. 2C shows an example user interface for displaying statistics about conversions.

FIG. 2D shows an example user interface for displaying suggested bids.

FIG. 2E shows an example user interface for displaying budgetary information and projected results associated with suggested bid adjustments.

FIG. 3 is a flowchart of an example process for using estimated conversion information to make adjustments to campaigns.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described, including a method for updating campaigns based on estimates provided by a content sponsor (e.g., an advertiser). For example, a content sponsor can be identified that is associated with one or more campaigns for presenting content to users. The content sponsor can be provided with a prompt for providing conversion estimates (e.g., within a user interface associated with a campaign management tool). Other information can be included with the prompt. For example, instructions for how to generate the estimates can be included. The instructions can describe how estimates may be generated based on other factors known to the content sponsor (such as a percentage of overall revenue is derived from certain conversion actions). Further, an explanation can be provided for how the estimates will be used to modify the content sponsor's campaign(s). The prompt can indicate that the content sponsor is to provide one or both of conversion value information (e.g., associated with each of a plurality of different conversion actions) or estimates for one or more conversion actions. The estimates, for example, are for actions that the content sponsor or the content serving system is currently unable to directly measure or have measured. Example conversion actions can include a phone call to an entity associated with the content sponsor, a physical visit to a location associated with the content sponsor, a purchase at a physical location associated with the content sponsor, an offline conversion, a download of content or an application, or some other type of conversion action. Estimates provided by the content sponsor can be received by the campaign management tool. The campaign management tool, for example, can determine (updated) rates for conversions for each of the one or more conversion actions, including using the estimates and interaction data associated with the one or more campaigns to determine the rates. A suggestion component of the campaign management tool, for example, can use the determined rates to make a suggestion (e.g., a bid suggestion and/or a budget suggestion) to the content sponsor. In some implementations, the campaign management tool, for example, can automatically adjust one or more parameters associated with the one or more campaigns associated with the content sponsor.

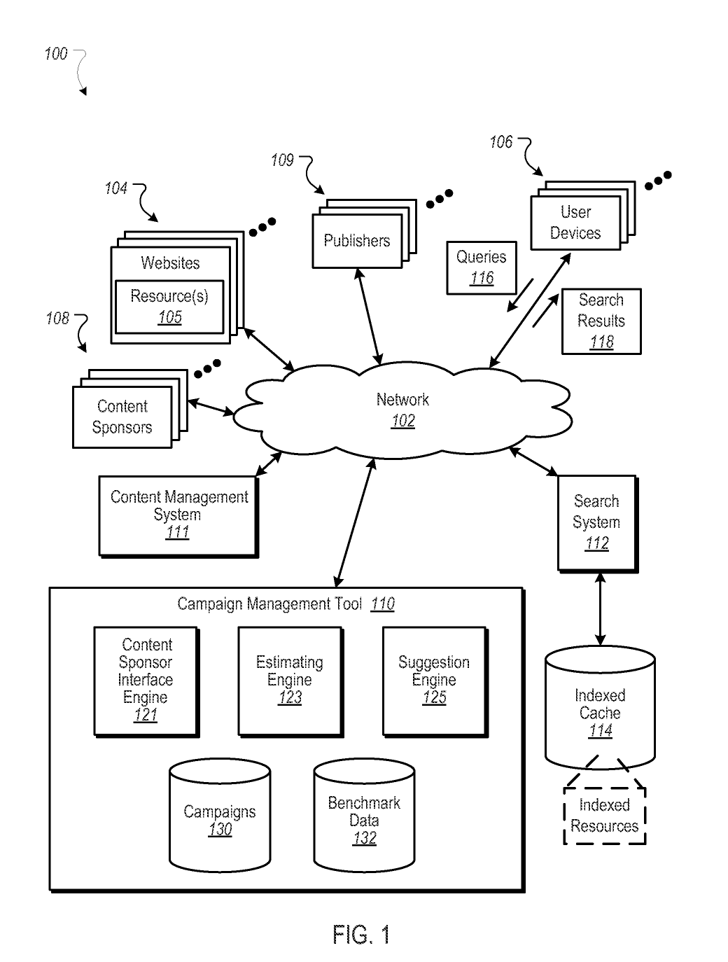

FIG. 1 is a block diagram of an example environment 100 for providing content. The example environment 100 includes a campaign management tool 110 for use by content sponsors for managing their campaigns, and a content management system 111 for selecting and providing content in response to requests for content. The campaign management tool 110, for example, can serve as a central user interface to assist a content sponsor to manage one or more campaigns that are being serviced by the content management system 111. The campaign management tool 110 can provide user interfaces and tools to create and manage campaigns including tools for presenting information related to performance metrics associated with the campaigns. The performance information can include rates, values, and other information that predict or report impressions, conversions or other actions associated with the content sponsor's campaigns. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, the campaign management tool 110, and the content management system 111. The example environment 100 may include many thousands of websites 104, user devices 106, content sponsors 108 and publishers 109.

The environment 100 can include plural data stores, which can be stored locally by the campaign management tool 110, stored somewhere else and accessible using the network 102, generated as needed from various data sources, or some combination of these. Further, some data stores described herein may include identifiers that can be used to match or access corresponding data records or other information that are stored elsewhere, e.g. locally and/or remotely.

A data store of campaigns 130, for example, can include information for campaigns stored (e.g., in inventory of the content management system 111) for plural content sponsors 108. For example, campaign information (e.g., for advertisement campaigns) can include information related to creatives used in each campaign, including presentation parameters and bid amounts specified by the respective content sponsor 108. In some implementations, campaigns for any given content sponsor 108 can be associated with different accounts, both accounts owned by the same content sponsor. Information stored for campaigns 130 can include measured data (e.g., conversion actions that are attributable to presentation of content from a campaign), estimates (as discussed below), and rate information (e.g., predicted rates based on the measured data and the estimates).

A data store of benchmark data 132, for example, can include benchmark conversion information, e.g., organized by business areas (e.g., verticals) and/or businesses in a similar geography and size to a given content sponsor. For example, the benchmark data can indicate under-reported or un-captured conversion rates from various sources, e.g., store visits, store purchases, application downloads, etc. The information can be collected from studies that have been performed by the campaign management tool 110 or by third parties.

The campaign management tool 110 can include plural engines, some or all of which may be combined or separate, and may be co-located or distributed (e.g., connected over the network 102). A content sponsor interface engine 121, for example, can provide information and control to user interface screens that are presented to the user as part of the campaign management tool 110. For example, the content sponsor interface engine 121 can access campaign information from the data store of campaigns 130 to provide data for presentation to the user. The content sponsor interface engine 121 can also access benchmark data 132, e.g., to include benchmark data for presentation to the user for use by the user in providing useful estimates.

An estimating engine 123, for example, can manage estimates associated with a campaign, including generating estimated click-through rates, conversions, conversion rates, values of conversions, return on investment, value to a campaign associated with increased conversions, and other estimates. The estimates, for example, can be based on existing campaign information (e.g., actual conversion counts and other measured information) and estimates provided by content sponsors (e.g., estimated conversions for specific conversion actions within a period of time and/or associated with specific device types, a geography, and/or other qualifying information).

A suggestion engine 125, for example, can provide suggestions associated with a campaign. For example, suggestions can include a suggested maximum bid for use in a particular campaign. In some implementations, suggestions can be specific to bids associated with certain kinds of impressions of content, e.g., to users having particular device types (e.g., mobile versus non-mobile and or other segmentations) or by location (e.g., city, state, country, region or other area).

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. Search results pages can also include one or more slots in which other content items (e.g., advertisements) can be presented.

When a resource 105, search results 118 and/or other content (e.g., a video) are requested by a user device 106, the content management system 111 receives a request for content. The request for content can include characteristics of the slots that are defined for the requested resource or search results page, and can be provided to the content management system 111.

For example, a reference (e.g., URL) to the resource for which the slot is defined, a size of the slot, and/or media types that are available for presentation in the slot can be provided to the content management system 111 in association with a given request. Similarly, keywords associated with a requested resource (“resource keywords”) or a search query 116 for which search results are requested can also be provided to the content management system 111 to facilitate identification of content that is relevant to the resource or search query 116.

Based at least in part on data included in the request, the content management system 111 can select content that is eligible to be provided in response to the request (“eligible content items”). For example, eligible content items can include eligible ads having characteristics matching the characteristics of ad slots and that are identified as relevant to specified resource keywords or search queries 116. In addition, when no search is performed or no keywords are available (e.g., because the user is not browsing a webpage), other information, such as information obtained from one or more snapshots, can be used to respond to the received request. In some implementations, the selection of the eligible content items can further depend on user signals, such as demographic signals, behavioral signals or other signals derived from a user profile.

The content management system 111 can select from the eligible content items that are to be provided for presentation in slots of a resource or search results page based at least in part on results of an auction (or by some other selection process). For example, for the eligible content items, the content management system 111 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

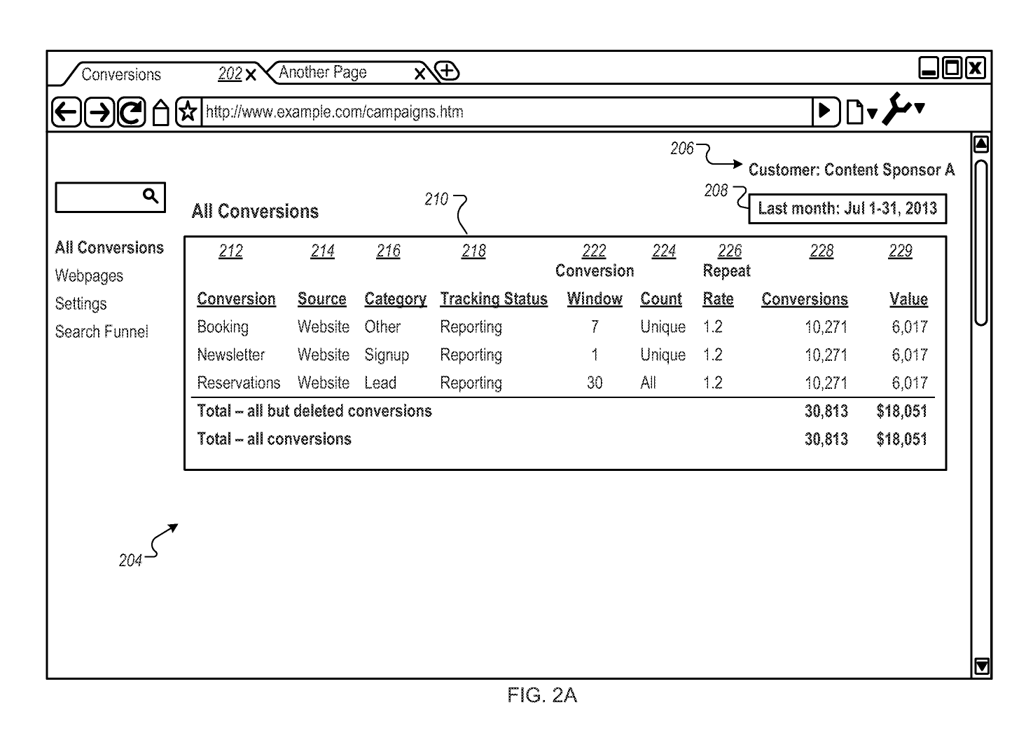

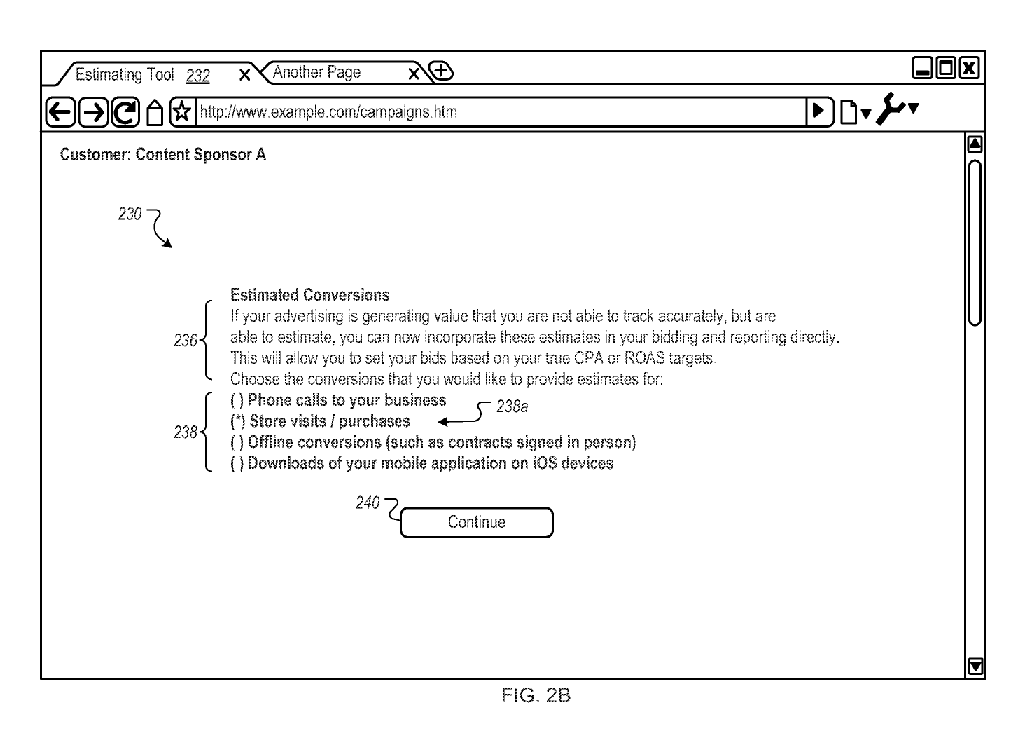

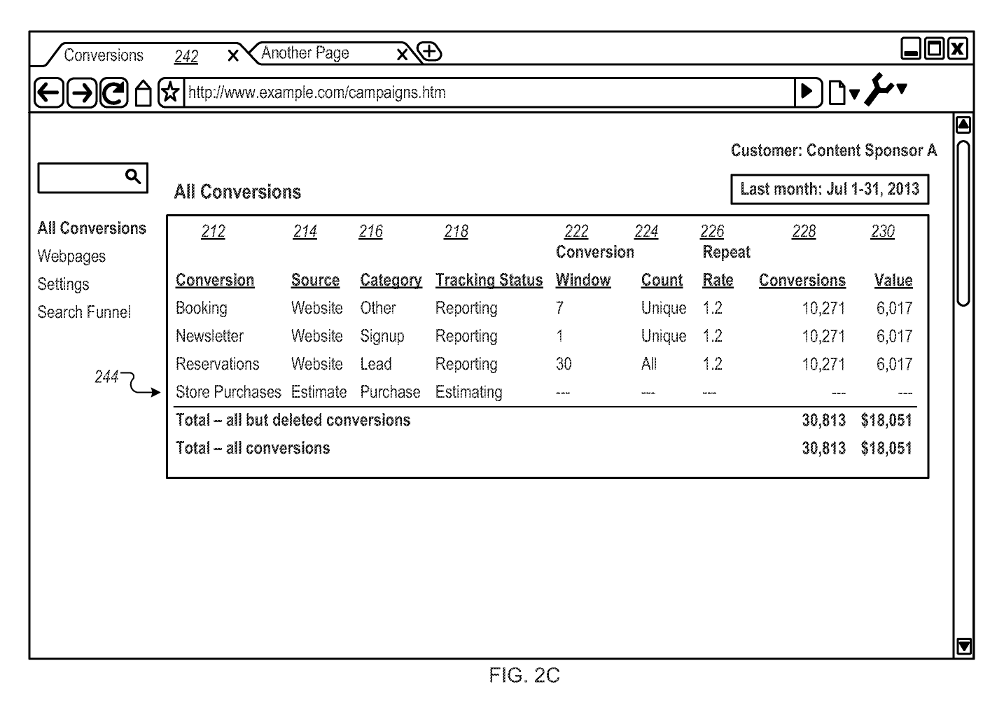

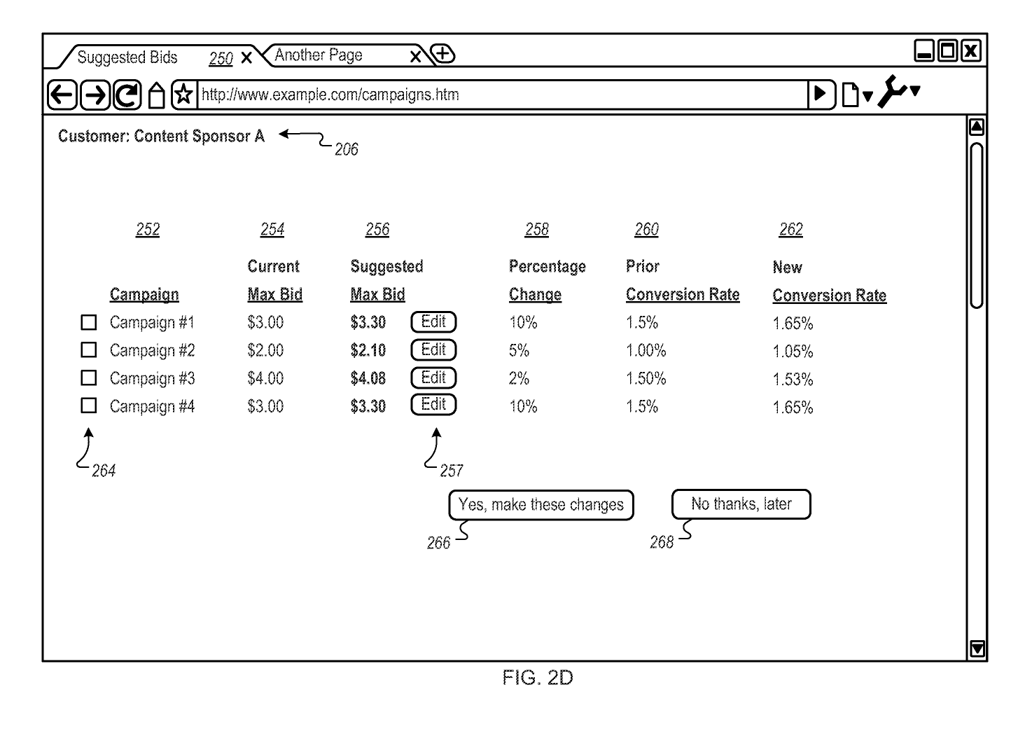

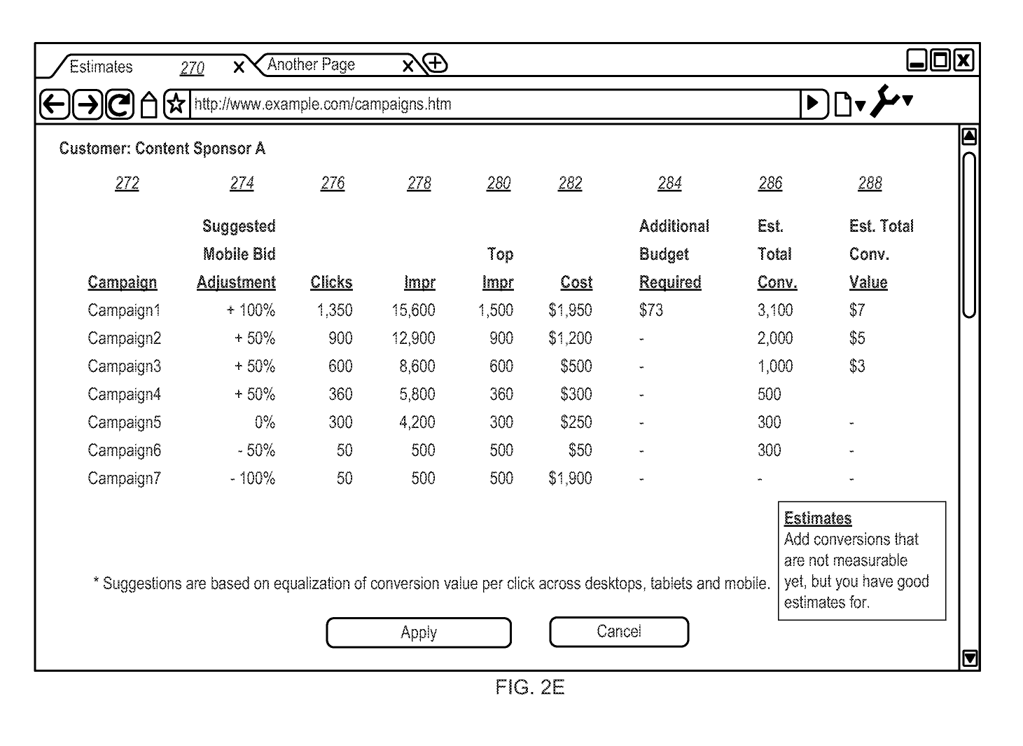

FIG. 2A shows an example user interface for displaying conventional conversion information associated with a content sponsor's campaign. For example, the user interface can include a page 202 that provides conversion information 204 associated with a customer 206 (e.g., Content Sponsor A) and a period of time 208. A conversion data area 210, for example, can list conversion information for different conversion actions 212 (e.g., Booking, Newsletter, Reservations) of conversion sources 214 (e.g., Website). The conversion data area 210 can also list conversion categories 216, conversion tracking status 218 and conversion window information 222 (e.g., a number of days after a user interaction on an advertisement during which the conversion action is attributable to the content sponsor's campaign). Conversion count 228 (Unique or All) represents whether user actions should be counted as separate conversions or only unique user actions should be counted as conversions. Repeat rate 226 indicates how often a given user performs a conversion action after an eligible user interaction with the advertisement, and a value field 229 identifies the revenue for each conversion action 212. In some implementations, the user interface, including the page 202, can be provided by the content sponsor interface engine 121.

FIG. 2B shows an example user interface including a prompt 230 for entering estimates or other conversion information. For example, the prompt 230 can appear on an estimating tool page 232 provided by the content sponsor interface engine 121. The prompt 230 can include an information block 236 that explains to the user (e.g., Content Sponsor A) how estimated conversions entered by the user may be used. The prompt 230 includes controls 238 for selecting from among different conversion actions for which estimates are to be provided. A selected control 238a (e.g., for the “store visits/purchases” conversion action) is currently selected, as shown in FIG. 2B, and as such, will be the subject of conversion estimates entered by the user in subsequent screens. In some implementations, subsequent screens can be provided by the content sponsor interface engine 121 upon selection of a continue control 240.

In some implementations, users can be presented with information provided on the estimating tool page 232 or elsewhere in pages associated with the campaign management tool 110 that notify the user about the use of estimates. For example, the campaign management tool 110 can notify the user that, if estimates are not provided by the user, the campaign management tool 110 will use its own estimates by default. In some implementations, user settings provided by the campaign management tool 110 can be used to specify when and how estimates are to be provided, and by whom, and how they are used.

FIG. 2C shows an example user interface for displaying statistics about conversions. For example, a conversions data page 242, provided by the content sponsor interface engine 121, can include the same or different information provided on the page 202 described with reference to FIG. 2A. As shown in FIG. 2C, conversion estimates 244 are included, e.g., based on estimates provided by the content sponsor for the conversion action related to “Store Purchases” after responding to the prompt 230 and subsequent pages. In this example, because the conversion information is based on estimates provided by the user (e.g., Content Sponsor A), the conversion tracking status 218 is set to “Estimating.” If the campaign management tool 110 subsequently receives actual conversion numbers associated with the estimates, for example, the conversion tracking status 218 can change to indicate the use of actual conversion values. In some implementations, the conversions data page 242 can be used to display and manage information for conversion actions (e.g., store visits/purchases) that are new to a campaign, e.g., created using conversion estimates provided by the content sponsor.

FIG. 2D shows an example user interface for displaying suggested bids. For example, the content sponsor interface engine 121 can provide a suggested bids page 250. For each of campaigns 252, for example, the suggested bids page 250 can display the current maximum bid 254 and a suggested maximum bid 256. For example, each suggested maximum bid 256 for a given campaign 252 can be a bid generated by the suggestion engine 125 based on estimated and actual conversion information that is available. In the current example, the suggested maximum bids 256 can be based on conversion estimates recently provided by the user, as explained above. Controls 257, provided adjacent to corresponding suggested maximum bids 256, can allow the user to change bids, e.g., after comparing the suggested maximum bids 256 to the current maximum bid 254. Percentage change values 258 can indicate, using a percentage, a difference in the current values of the suggested maximum bids 256 relative to the current maximum bid 254. Additional information displayed to the user can aid the user in deciding what settings of suggested maximum bids 256 should be used, including prior conversion rates (e.g., rates computed before receipt of the estimate data) 260 and new conversion rates (e.g., rates based on the received estimate data) 262. For example, the prior conversion rates 260 can be based on current maximum bids 254. New conversion rates 262 can be based, for example, on an estimated conversion rate and are used to determine the suggested maximum bid 256. Controls 264, when selected for corresponding campaigns 252, can permit the user to indicate which of the suggested maximum bids 256 are to be incorporated into the corresponding campaigns 252. For example, based on selections made using controls 264, the corresponding suggested maximum bids 256 can be incorporated into campaigns 252 by selecting an update control 266 (e.g., “yes, make these changes”). Control 268 can be used to cancel any pending suggested maximum bids 256. Other controls are possible.

FIG. 2E shows an example user interface for displaying budgetary information and future estimate figures associated with suggested bid adjustments. For example, an estimates page 270 can provide information associated with campaigns 272. Suggested mobile bid adjustments 274, for example, can provide the user with suggested bid adjustments, e.g., including suggested bids that have been generated by the suggestion engine 125 based on estimates provided by the user. Clicks 276, impressions 278, and top impressions 280 can indicate estimated clicks and impressions that would likely result by making the suggested mobile bid adjustments 274. Costs 282 and additional budget values 284 can also be projected estimates, e.g., based on the suggested mobile bid adjustments 274. Estimated total conversions 286 and estimated total conversion values 288 can provide an indication, to the user, of projected conversions and return on investment. Other types of information (such as other types of performance metric information) can be displayed for each of the campaigns 272.

In some implementations, other user interface pages can be provided. For example, a page can be provided that displays account-wide estimated total conversions, values, and rates segmented by conversion type and device. In some implementations, other dialogs and prompts can be provided, e.g., along the lines of “These estimates have increased your estimated conversion rate from 0.63% to 0.67% (6.3% increase in some of your campaigns). Would you like to adjust your Max Bids for such campaigns proportionally in order to reflect your returns better?” In some implementations, other ways of presenting information can be used, e.g., including graphs and/or other displays that update automatically based on user inputs, including based on user interaction with slider controls.

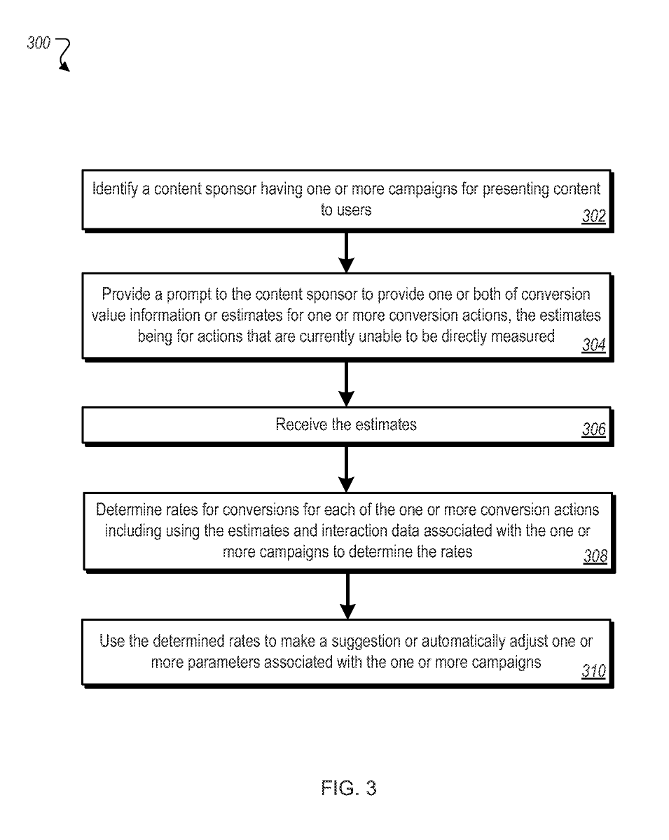

FIG. 3 is a flowchart of an example process 300 for using estimated conversion information, such as to make adjustments to campaigns. In some implementations, the content management system 111 can perform steps of the process 300 using instructions that are executed by one or more processors. FIGS. 1-2E are used to provide example structures for performing the steps of the process 300.

A content sponsor is identified that has one or more campaigns for presenting content to users (302). For example, the content sponsor interface engine 121 (FIG. 1) can identify Campaign Sponsor A, such as at the time that Campaign Sponsor A initiates or uses the estimating tool page 232 (FIG. 2B) or some other interface for managing campaigns. For example, the campaigns for which the estimating tool page 232 is used can be advertising campaigns for presenting advertisements to users. The estimating tool page 232, for example, can be one of several functions available in a content sponsor interface.

In some implementations, the one or more campaigns can include a first campaign and a second different campaign, wherein the first campaign and the second different campaign are in different accounts, both accounts owned by the same content sponsor. For example, the identified content sponsor may have multiple campaigns, each potentially belonging to a different account associated with the user (e.g., Content Sponsor A). Referring to FIG. 2D, for example, campaigns 252 are associated with the customer 206 (e.g., Content Sponsor A).

A prompt is provided to the content sponsor to provide one or both of conversion value information or estimates for one or more conversion actions, the estimates being for actions that are currently unable to be directly measured (304). For example, estimating tool page 232 can present the prompt 230 using information provided by the content sponsor interface engine 121. The prompt 230 can include the informational block 236 that explains to the user (e.g., the Content Sponsor A) how estimated conversions function within the content sponsor interface. For example, the user can respond to the prompt 230 if the user can provide estimates for user actions for which there may be no current or accurate measurements. The prompt 230, for example, can be associated with the one or more campaigns, and can appear in an interface (e.g., the estimating tool page 232) associated with the campaign management tool 110.

In some implementations, the prompt 230 can include controls 238, e.g., that allow the user to designate that conversion estimates are to be input by the user for one of the specific types of conversion actions. In some implementations, example conversion actions include: a phone call to an entity associated with the content sponsor, a physical visit to a location associated with the content sponsor, a purchase at a physical location associated with the content sponsor, an offline conversion, or a download of content or an application. Other types of conversion actions are possible. In some implementations, different kinds of conversions can exist. For example, a phone call to an entity associated with the content sponsor can be a phone call associated with (or made form) a phone number and/or control on a content item (e.g., an advertisement), or a phone call associated with a phone number that is displayed on a web page. Other types of phone calls are possible.

In some implementations, some conversion actions can be further distinguished or differentiated into subgroups. For example, phone calls can include calls from ads and calls from websites. Calls from ads, for example, can represent call conversions on mobile phones (e.g., tracked to clicks on call extensions) as well as manually-dialed calls to phone numbers listed on desktop call extensions. Calls from websites can represent the website-related call metrics. Other break-downs of conversion actions are possible.

In some implementations, after the user selects one or more of the controls 238, additional screens can appear for entering conversion estimates. For example, if the user selects control 238a for store visits/purchases, then an additional interface can be provided in which the user can designate an estimated number of conversions that are store visits or purchases, along with other identifying information that quantifies the estimates.

In some implementations, the estimates can be estimates for one or more time periods in the past. For example, the user can designate a month, a week, or some other time period to which the estimates correspond. In some implementations, the estimates for the one or more time periods in the past can be estimates for one or more segments of users, wherein the segments are based on one or more of location, device type, or time of day/week.

In some implementations, the content sponsor will be prompted (e.g., so as to avoid misinterpretation of a denominator to use in an estimated conversion action rate), to input an absolute number of conversion actions that have occurred in a time period (e.g., of their choosing). In some implementations, conversion rates (and updated conversion rates) can then be computed based on the number of impressions and conversion counts (e.g., conversion count divided by the eligible clicks during the period). In some implementations, content sponsors can be prompted to provide data associated with more than one time period, so as to reduce or minimize sampling bias. Rates can be computed based on eligible interactions (e.g., clicks). For example for a given action (call a predefined number), eligible clicks are those that are associated with an advertisement that included a prescribed telephone number for the call. Other clicks on other advertisements would not be eligible. Rate determination is discussed in greater detail below.

In some implementations, a content sponsor can also be prompted to provide conversion action value information. Conversion action value information reflects a value to the content sponsor of a particular conversion action occurring. The value information can be used to compute performance metrics related to the one or more campaigns of a content sponsor. Time periods can also be specified for conversion value information.

In some implementations, other qualifying information in addition to time periods in the past can be provided with conversion value information or estimates. For example, the conversion value information or estimates can be provided for a segment of users based on one or more of location (e.g., geographic location, city, state, region or other location) device type (e.g., mobile versus non-mobile, specific type(s) of device, or other device-identifying information). Other types of qualifying information associated with conversion value information or estimates are possible.

In some implementations, the estimates can be estimates for an amount of conversion actions that are attributable to presentation of content from the one or more campaigns. For example, the content sponsor can provide conversion value information or estimates that include or quantify numbers of user actions (e.g., purchases) that are associated with specific campaigns of the user (e.g., advertisement campaigns for Content Sponsor A).

In some implementations, the process 300 can further include providing benchmarks for similar businesses in a similar geography and or of similar size to the content sponsor so as to facilitate the generation by the content sponsor of the estimates. For example, when presenting prompts and/or information to the user, the content sponsor interface engine 121 can include benchmark information, e.g., that identifies estimates or other information associated with other entities and their respective values in similar verticals or other common segments as compared with the content sponsor's campaign. The benchmarks can include, for example, industry-wide and/or vertical-specific, e.g., that the content sponsor can view when providing conversion value information or estimates. The user can use the information, for example, when using the content sponsor interface engine 121 to specify conversion value information or estimates.

In some implementations, the estimates can be based on benchmarks for similar businesses in a similar geography to the content sponsor. For example, if Content Sponsor A is a content sponsor associated with shoes, then estimates that are provided by the estimating engine 123 can be based on benchmarks associate with shoe businesses.

In some implementations, prompting includes determining when estimates are not available from the content sponsor and using benchmarks for similar businesses in a similar geography and/or size to the content sponsor as a proxy for the estimates. For example, the content sponsor interface engine 121 can display benchmark data 132 associated with a particular conversion action for use by the content sponsor in generating an estimate.

In some implementations, information can be provided to the content sponsor to facilitate easy determination of estimates. For example, a content sponsor may use a different phone number for a call extension associated with a campaign and can simply count how many customers called that number and converted over a 4-week period. In another example, a content sponsor can publish a different phone number on their website. The content sponsor may be provided with instructions to use a simple estimation using a ratio which assumes that a campaign (or more than one campaign) drives the same ratio of business from a measure source (such as web conversions) as an unmeasured source (such as store purchases). Say an advertiser sells 5 times as many times in-store than on the web, and 100 web conversions in a week, this method will estimate 500 store conversions can be attributed to the campaigns. Further, aside from estimates computed from experimental or direct measurements, a content sponsor may subscribe to marketing research from a trusted third part for assistance in generating the estimates.

Returning to the method, the estimates are received (306). For example, the campaign management tool 110 can receive the estimated conversions (e.g., for store visits/purchases) entered by the content sponsor. In some implementations, the estimates can be received by the content sponsor interface engine 121 and provided to the estimating engine 123.

(Updated) rates for conversions are determined for each of the one or more conversion actions, including using the estimates and interaction data associated with the one or more campaigns to determine the rates (308). For example, the estimating engine 123 can estimate conversion rates based on information (e.g., estimates for conversions associated with store visits/purchases) received from the user. The estimated conversion rates can correspond, for example, to one or more identified campaigns associated with the user (e.g., campaign Sponsor A). FIGS. 2D and 2E provide examples for interfaces that can be presented to a content sponsor related to estimated conversions that are determined.

In some implementations, determining the rates for conversions can further include identifying past rates for each of the conversion actions and estimating a future (e.g., an updated) rate for the conversion actions based on respective ones of the determined rates. For example, based on a received estimate for conversions associated with store visits and purchases, the estimating engine 123 can estimate future conversion rates for campaigns belonging to the user, e.g., Content Sponsor A's campaigns. A future rate (e.g., Y %) can be estimated, for example, based on past rates (e.g., X %) in combination with the received conversion value information or estimates. Further, the estimates can be made using any provided qualifying information, e.g., including time periods and segment-related information (e.g., location, device type). For example, referring to FIG. 2D, new conversion rates 262 are based on prior conversion rates 260 in combination with current settings on the suggested maximum bids 256.

In some implementations, determining rates can include computing the rates based at least on identifying eligible user interactions and comparing the user interactions with other measured data. For example, different click types (e.g., website clicks, click-to-call clicks, app download clicks, location extension clicks) are to be counted as eligible for conversions in different ways, depending on the conversion action (e.g., calls from ads, calls from websites, in-store conversions, app conversions, or offline).

The determined rates are used to make a suggestion or automatically adjust one or more parameters associated with the one or more campaigns (310). As an example, based on the determined conversion rates (e.g., for conversions associated with store visits/purchases) estimated by the estimating engine 123, the suggestion engine 125 can make suggestions associated with the user's campaigns.

In some implementations, using the determined rates can further include making a suggestion of a bid adjustment for at least one of the one or more campaigns. For example, using one or more screens provided by the content sponsor interface engine 121, the suggestion engine 125 can suggest, for the user, changes to bids that are based on estimated conversions. In some implementations, making the suggestion of a bid adjustment can be based, at least in part, on information associated with a corresponding campaign, e.g., campaign goals, budgets, or other campaign information. FIG. 2D provides examples of interfaces associated with suggested bids.

In some implementations, using the determined rates can further include determining one or more goals of the content sponsor associated with a campaign of the one or more campaigns, evaluating the goals based at least on the determined rates, and making a suggestion to adjust (or automatically adjusting) a bid associated with the campaign. The suggestion engine 125, for example, can access stored campaign goals for campaigns associated with the user (e.g., Content Sponsor A). Based on the goals (e.g., to achieve a higher number conversions, a threshold return on investment, or other goals), the suggestion engine 125 can automatically change or merely suggest changing (e.g., increasing or decreasing) one or more bids associated with a campaign in order to achieve a desired outcome. FIG. 2D shows examples of user interfaces associated with suggestions to increase bids.

In some implementations, the process 300 can further include determining when measured data is available for one or more of the estimates and using the measured data in lieu of the estimates when determining the (updated) rates. For example, actual measured data can be captured and provided by one or more content management and distribution systems or other sources. Advertiser serving systems, for example, can provide actual conversion statistics and/or other information about user interactions with content items. When these or other types of actual, measured information is available, the information can be used instead of estimates that has been received from content sponsors. In some implementations, received data can be partitioned and/or indexed, e.g., so as to facilitate the use of actual measured information over estimates, to the fullest extent possible. For example, actual measured data can replace a content sponsor's estimates for conversions related to store visits/purchases for a given time period.

In some implementations, the process 300 can further include presenting one or more of return on investment, net profit, margin, cost per action or another return metric to the content sponsor for a campaign of the one or more campaigns based on the received conversion value information and the determined rates. For example, the content sponsor interface engine 121 can provide one or more interfaces, such as described with reference to FIG. 2E to present the return metric information.

In some implementations, the process 300 can further include determining estimated conversions that are attributable to user interactions, the estimated conversions represented by the received estimates, wherein determining rates is based on the attributable user interactions and a number of estimated conversions for a given conversion action. For example, the estimating engine 123 can use the received estimates in combination with what is known about conversions associated with user interactions for the user's campaigns in order to estimate conversions that correspond to specific types of conversion actions. For example, conversion estimates provided for store visits/purchases can be attributed to specific user actions.

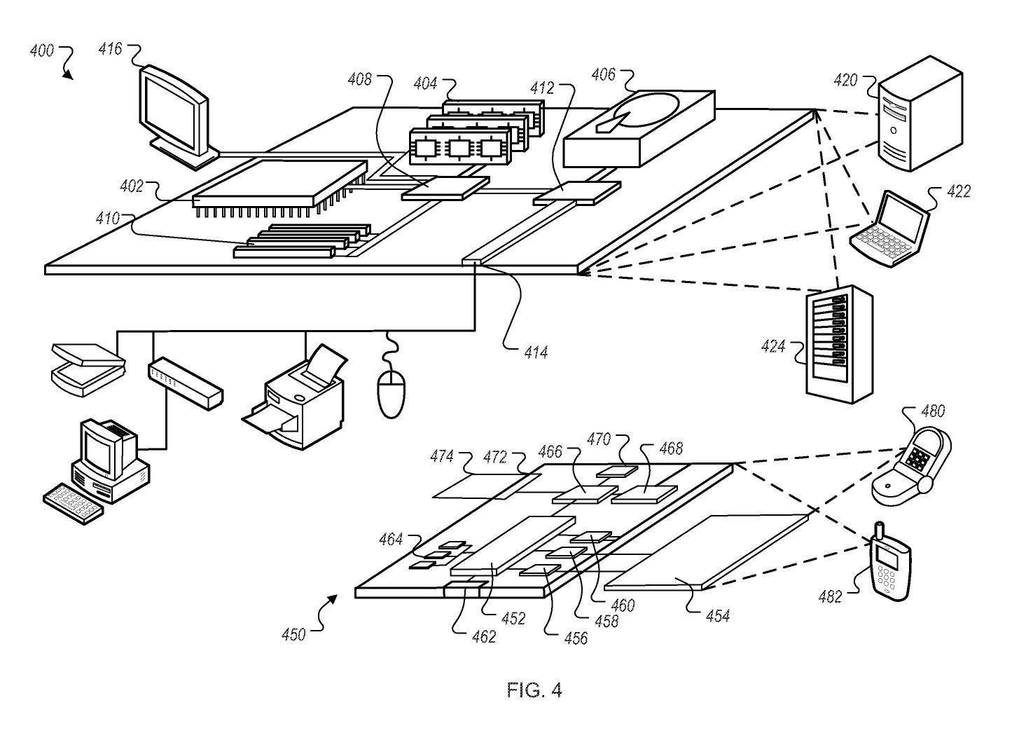

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processors embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying, by one or more processors, a content sponsor having a campaign for presenting content to users;
providing, over a computer network and for presentation in an electronic user interface, a prompt requesting that the content sponsor provide, through the electronic user interface, estimates for one or more conversion actions associated with the campaign, the estimates being for user actions that have not been directly measured;
receiving, over the computer network and through the electronic user interface, the estimates for the campaign input by the content sponsor;
determining, by the one or more processors, rates for conversions for each of the one or more conversion actions including using the estimates and directly measured user interaction data associated with the campaign to determine the rates;
automatically adjusting, by the one or more processors and based at least on the determined rates, one or more parameters of the campaign;
after adjusting the one or more parameters, capturing actual measured data for one of the user actions that were not previously directly measured, wherein the actual measured data is captured through feedback provided by multiple different device types including at least mobile devices and desktop devices;
determining, by the one or more processors, updated rates for conversions using the actual measured data instead of the received estimate for the one of the user actions, including replacing the estimate with the actual measured data provided through the feedback; and
automatically optimizing the one or more parameters based on the updated rates, wherein the optimizing includes adjusting the one or more parameters to values that will achieve a given level of performance based on the updated rates.

2. The method of claim 1 wherein each conversion action is one of a phone call to an entity associated with the content sponsor, a physical visit to a location associated with the content sponsor, a purchase at a physical location associated with the content sponsor, an offline conversion, or a download of content or an application.

3. The method of claim 1 wherein providing a prompt includes providing, by a campaign management tool associated with the campaign, a prompt in an interface associated with the campaign management tool.

4. The method of claim 1 wherein the estimates are estimates for one or more time periods in the past.

5. The method of claim 1 wherein the estimates are estimates for an amount of conversion actions that are attributable to presentation of content from the campaign.

6. The method of claim 1 wherein determining the rates further includes identifying past rates for each of the conversion actions and estimating a future rate for the conversion actions based on respective ones of the determined rates.

7. The method of claim 1 further comprising determining when measured data is available for one or more of the estimates and using the measured data in lieu of the estimates when determining the rates.

8. The method of claim 1 wherein using the determined rates further includes making a suggestion of a bid adjustment for at least one of the campaign.

9. The method of claim 1 wherein using the determined rates further includes determining one or more goals of the content sponsor associated with the campaign, evaluating the goals based at least on the determined rates, and making a suggestion to or automatically adjust a bid associated with the campaign.

10. The method of claim 1 further comprising presenting one or more of return on investment, net profit, margin, cost per action or another return metric to the content sponsor for the campaign based on the received conversion value information and the determined rates.

11. The method of claim 1 further comprising determining estimated conversions that are attributable to user interactions, the estimated conversions represented by the received estimates and wherein determining rates is based on the attributable user interactions and a number of estimated conversions for a given conversion action.

12. (canceled)

13. The method of claim 4 wherein the estimates are estimates for one or more segments of users wherein the segments are based on one or more of location, device type, or time of day/week.

14. The method of claim 1 further comprising providing benchmark information for businesses that are similar to a business of the content sponsor and are in a geography that is similar to a geography of the content sponsor.

15. The method of claim 14 wherein the estimates are based at least on the benchmark information.

16. The method of claim 15 wherein determining the rates for the conversions includes using the benchmark information instead of the estimates when the estimates are not available from the content sponsor.

17. The method of claim 1 wherein determining rates includes computing the rates based at least on identifying eligible user interactions and comparing the user interactions with other measured data.

18. A computer program product embodied in a non-transitory computer-readable medium including instructions, that when executed, cause one or more processors to:
identify a content sponsor having a campaign for presenting content to users;
provide, over a computer network and for presentation in an electronic user interface, a prompt requesting that the content sponsor provide, through the electronic user interface, estimates for one or more conversion actions associated with the campaign, the estimates being for user actions that have not been directly measured;
receive, over the computer network and through the electronic user interface, the estimates for the campaign input by the content sponsor;
determine rates for conversions for each of the one or more conversion actions including using the estimates and directly measured user interaction data associated with the campaign to determine the rates;
automatically adjust, based at least on the determined rates, one or more parameters of the campaign;
after adjusting the one or more parameters, capture actual measured data for one of the user actions that were not previously directly measured, wherein the actual measured data is captured through feedback provided by multiple different device types including at least mobile devices and desktop devices;
determine updated rates for conversions using the actual measured data instead of the received estimate for the one of the user actions, including replacing the estimate with the actual measured data provided through the feedback; and
automatically optimize the one or more parameters based on the updated rates, wherein the optimizing includes adjusting the one or more parameters to values that will achieve a given level of performance based on the updated rates.

19. The computer program product of claim 18 wherein each conversion action is one of a phone call to an entity associated with the content sponsor, a physical visit to a location associated with the content sponsor, a purchase at a physical location associated with the content sponsor, an offline conversion, or a download of content or an application

20. A system comprising:
one or more processors; and
one or more memory elements including instructions that, when executed, cause the one or more processors to:
identify a content sponsor having a campaign for presenting content to users;
provide, over a computer network and for presentation in an electronic user interface, a prompt requesting that the content sponsor provide, through the electronic user interface, estimates for one or more conversion actions associated with the campaign, the estimates being for user actions that have not been directly measured;
receive, over the computer network and through the electronic user interface, the estimates for the campaign input by the content sponsor;
determine rates for conversions for each of the one or more conversion actions including using the estimates and directly measured user interaction data associated with the campaign to determine the rates;
automatically adjust, by the one or more processors and based at least on the determined rates, one or more parameters of the campaign;
after adjusting the one or more parameters, capture actual measured data for one of the user actions that were not previously directly measured, wherein the actual measured data is captured through feedback provided by multiple different device types including at least mobile devices and desktop devices;
determine updated rates for conversions using the actual measured data instead of the received estimate for the one of the user actions, including replacing the estimate with the actual measured data provided through the feedback; and
automatically optimize the one or more parameters based on the updated rates, wherein the optimizing includes adjusting the one or more parameters to values that will achieve a given level of performance based on the updated rates.
